(19) United States
(12) Patent Application Publication
(10) Pub. No.: US 2012/0105734 A1
(43) Pub. Date: May 3, 2012

(54) Multi-Panel Display Device

(76) Inventors: Zakiyaa Jada Johnson, Fort Lauderdale, FL (US); Hana Abdul Majid, Hampton, GA (US)

(21) Appl. No.: 13/287,817

(22) Filed: Nov. 2, 2011

Related U.S. Application Data
(60) Provisional application No. 61/409,458, filed on Nov. 2, 2010.

(51) Int. Cl. H04N 9/12; H04N 5/44; H04N 5/60; H04N 5/64; H04N 5/50

(52) U.S. Cl. 348/731; 348/739; 348/836; 348/738; 348/734; 348/E09.012; 348/E05.097; 348/E05.129; 348/E05.125

(57) ABSTRACT

A unitary multi-panel display device is described that includes a housing, a single inner operating component, and at least two displays installed in the housing for viewing to video or other images displayed thereon and listening to audio content played thereon. The display device can be a television, a computer monitor, a handheld computing device, a handheld gaming device, a handheld multimedia device, or any other suitable device that can be used to view video or to view and listen to multimedia content. The singular device allows the viewing of the same or different programs from opposite sides of the device, for example, viewing of the at least two displays from points of view facing anterior and posterior sides of a television embodiment of the device. The single inner operating component is capable of playing the same or different audio/video sources on the at least two displays.

### CROSS-REFERENCE TO RELATED APPLICATION

This application claims the priority from U.S. provisional patent application Ser. No. 61/409,458 filed Nov. 2, 2010. The foregoing application is incorporated in its entirety herein by reference.

### FIELD OF THE INVENTION

The present invention relates to a display device. More particularly, the invention relates to a multi-panel display device having at least two displays that are oriented in at least two directions for viewing from different positions around the device and at least one inner operating device for receiving and playing at least one audio/video source on the at least two displays.

### BACKGROUND

Currently, televisions and other display screen devices include only a single viewing surface (or display screen). Despite the extensive variety of televisions available on the market (e.g., LCD, LED, plasma, rear-projection, etc.), all are designed to be viewed on a single surface only, typically the front or anterior side.

Often, televisions are installed or arranged in places that leave the back or posterior surface exposed. Typically, the posterior surface of most, if not all, televisions today contain unsightly cordage and cables that connect the television to various other components, including VCR's, DVD players, cable boxes, electrical outlets, etc. Even if these cables and cordage are absent from the posterior side of the television, the surface remains under-utilized.

Additionally, when multiple individuals or groups of individuals desire to watch more than one media program (e.g., a television show or movie), multiple televisions must be installed or arranged in places in which these different or distinct groups of people may wish to view different programs.

Therefore, a need exists for a television that has multiple viewing surfaces, which can include both the anterior and posterior surfaces of the television, to allow for the viewing of multiple programs, or even the same program, concurrently.

### SUMMARY

The invention relates to a unitary multi-panel display device that features a housing, a single inner operating component for receiving and playing at least one audio/video source, and at least two displays installed in the housing for viewing video or other images displayed thereon or for viewing and listening to multimedia content. The multi-panel display device can also include at least one audio device such as, for example, a speaker, that plays audio content. The display device can be a television, a computer monitor, a handheld computing device, a handheld gaming device, a handheld multimedia device, or any other suitable device that can be used to view video or to view and listen to multimedia content. The multi-panel display device permits the viewing of the same or different programs from opposite sides of the device. For example, in an embodiment wherein the device is a television, the at least two displays of the television can be viewed from points of view facing anterior and posterior sides of the television. The single inner operating component is capable of playing the same or different audio/video sources on the at least two displays.

Accordingly, the invention features a multi-panel display device that includes a unitary device having a housing, a single inner operating component for receiving and playing at least one audio/video source, and at least two displays installed in the housing for viewing from two different points of view.

In another aspect, the invention can feature the at least two displays being electronic video displays.

In another aspect, the invention can feature the unitary device including a first display and a second display.

In another aspect, the invention can feature the first and second displays being positioned on first and second sides, respectively, of the unitary device.

In another aspect, the invention can feature the first and second sides of the unitary device being first and second opposite exterior sides of the unitary device's housing.

In another aspect, the invention can feature the unitary device being a television.

In another aspect, the invention can feature the television having the first display installed on an anterior side of the television's housing and the second display installed on a posterior side of the television's housing.

In another aspect, the invention can feature the unitary device being a computer monitor.

In another aspect, the invention can feature the unitary device being a handheld computing device, a handheld gaming device, a handheld multimedia device, or any other suitable device comprising at least two displays.

In another aspect, the invention can feature the at least one inner operating component being a single inner operating component.

In another aspect, the invention can feature the single inner operating component being capable of playing the same or different audio/video sources on the at least two displays.

In another aspect, the invention can feature the unitary device including at least one video source and at least one audio source.

In another aspect, the invention can feature the unitary device including first and second video sources and first and second audio sources.

In another aspect, the invention can feature the first and second displays being capable of displaying the first video source, or the second video source, or one of the first or second video source on the first display and the other of the first or second video source on the second display.

In another aspect, the invention can feature a join switch capable of being actuated to cause the first and second displays to play the same audio/video source.

In another aspect, the invention can feature the first display further including a first speaker for playing a first audio source from the first side and the second display further including a second speaker for playing a second audio source from the second side.

In another aspect, the invention can feature a single first remote control for controlling the at least two displays.

In another aspect, the invention can feature at least two separate remote controls programmed for separately controlling each of the at least two displays.

In another aspect, the invention can feature a multi-channel audio/video device for playing separate audio/video sources on each of the at least two displays.

In another aspect, the invention can feature the inner operating component including at least one receiver for receiving the at least one audio/video source for playback by the inner operating component on at least one of the at least two displays.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a left perspective view of a multi-panel display screen device having two display screens.

FIG. 2 is a right perspective view of the multi-panel display screen device of FIG. 1.

FIG. 3 is a side view of the multi-panel display screen device of FIG. 1.

### DETAILED DESCRIPTION

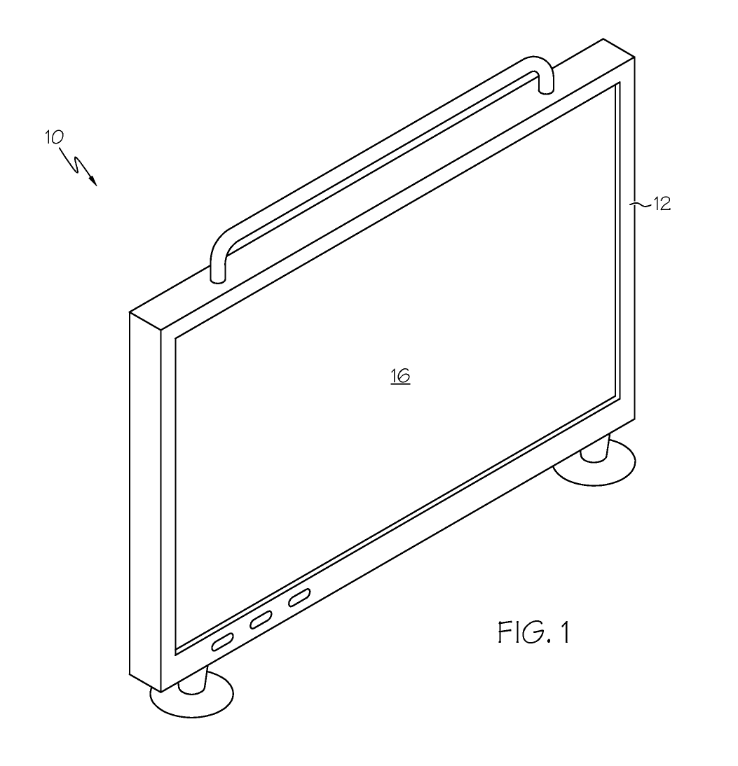

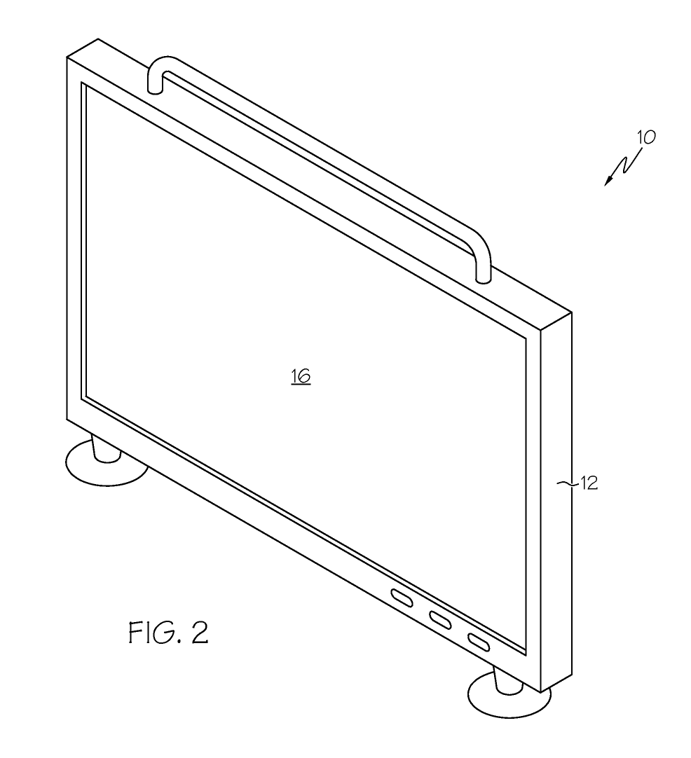

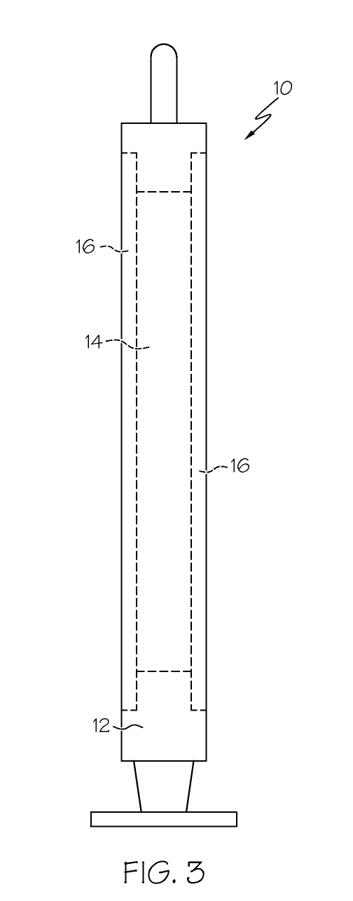

As shown in FIGS. 1-3, in an exemplary embodiment, the invention features a multi-panel display device 10 that can be a unitary device having a housing 12, at least one inner operating component 14 for receiving and playing at least one audio/video source, and at least two displays 16 installed in the housing for viewing from two different points of view. The unitary device can be a television, a computer monitor, a handheld computing device, a handheld gaming device, a handheld multimedia device, or any other suitable electronic device that conventionally includes a display for displaying and playing multimedia content. In an exemplary embodiment, the unitary device can be a television (e.g., a double-sided, or two-panel, television that can be operated, watched, and listened to from more than one point of view, i.e., vantage point. The at least one inner operating component 14 is communicatively connected to the at least two displays 16, and can be constructed from any electronic parts or other components, now known or created in the future, which are capable of receiving at least one audio/video source and playing the at least one audio/video source on at least two displays 16.

Each of the at least two displays can include at least one audio device connected thereto. The audio device (no shown in the drawings) can be any standard audio playback device such as, for example, a speaker, which is capable of playing audio content.

The housing 12 can be constructed in any shape, size, or from any material suitable for securing at least two displays 16 to the housing of the unitary device. The at least one inner operating component 14 is installed inside the housing 12 so as to be concealed from view outside the device 10. The displays can be electronic video displays of the type typically found installed on electronic devices capable of displaying video sources.

In an exemplary embodiment, the multi-panel display device 10 can include only a single inner operating component 14 for receiving and playing on the at least two displays 16 one or more audio/video sources. In other embodiments, the device can include two, three, four, or more inner operating components, each of which is capable of receiving at least one audio/video source and playing the at least one audio/video source on at least one display of the at least two displays of the device. Similarly, the device can include two, three, four, or more displays communicatively connected to the at least one inner operating component.

In an exemplary embodiment, the unitary device can feature a first display and a second display. The first and second displays can be positioned on first and second sides, respectively, of the unitary device. The first and second sides of the unitary device can be first and second opposite exterior sides of the unitary device's housing.

In a more exemplary embodiment, the unitary device can be a television, and the television can have the first display installed on an anterior side of the television's housing and the second display installed on a posterior side of the television's housing. In other embodiments, the unitary device can be a handheld computing device, a handheld gaming device, a handheld multimedia device, or any other suitable device comprising at least two displays 16. The television or other unitary device of the invention is not limited herein in type and can be any type of now known or created in the future including, but not limited to, devices that are HD (i.e., high-definition), 3D (i.e., three-dimensional), LCD, LED, plasma, Blue-ray, touchscreen, wireless, or combinations of the foregoing. The invention also contemplates and includes unitary devices that are powered by connection to an electrical power source, solar-powered devices, and battery-powered device.

The unitary device can include at least one video source and at least one audio source. In one embodiment, the unitary device can include first and second video sources and first and second audio sources. The first display can further include a first speaker for playing a first audio source from the first side, and the second display can further include a second speaker for playing a second audio source from the second side.

The first and second displays can be capable of displaying the first video source or the second video source. The unitary device can also display one of the first or second video source on the first display and the other of the first or second video source on the second display. Audio corresponding to these video sources is automatically played by the unitary device through each display's associated speakers.

The unitary device can include a join switch capable of being actuated to cause the first and second displays to display the same audio/video source. The unitary device can feature a multi-channel audio/video device for playing separate audio/video sources on each of the at least two displays. Separate audio sources can be played through the first and second speaker devices.

In one embodiment, the multi-panel display device can feature a single first remote control for controlling the at least two displays. In another embodiment, at least two separate remote controls can be provided and programmed for separately controlling each of the at least two displays.

The at least one inner operating component of the multi-panel display device can include at least one receiver. The unitary device can include a single receiver that is capable of receiving more than one transmitted signal encoding multimedia content for display and playback on the display. In another embodiment, the unitary device can include more than one receiver so that transmitted encoded multimedia content signals can be received by one of the receivers and electronically routed by the unitary device to a display for playback and viewing by one or more individuals. In embodiments where the device includes a single inner operating component 14, the single inner operating component can feature one or more receivers, each of which is capable of receiving one or more audio/video sources for playback by the inner operating component on one or more of the at least two displays. In embodiments where the device includes more than one inner operating component 14, each inner operating component can include a separate receiver or plurality of receivers, each of which is capable of receiving one or more audio/video sources for playback by the inner operating component on one or more of the at least two displays. In another embodiment, the device can include a plurality of inner operating components 14 that are each communicatively connected to and share a single receiver that is capable of receiving at least one audio/video source from a transmission source (e.g., cable television connection, satellite television, analog television antenna signal, digital television antenna signal, DVD player, or other transmission source or device) for playback by the plurality of inner operating components on one or more of the at least two displays 16. In some embodiments, the receiver can be a television tuner, e.g., a digital television tuner.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A multi-panel display device comprising a unitary device comprising a housing, at least one inner operating component for receiving and playing at least one audio/video source, and at least two displays installed in the housing for viewing from two different points of view.

2. The multi-panel display device of claim 1, wherein the at least two displays are electronic video displays.

3. The multi-panel display device of claim 1, wherein the unitary device comprises a first display and a second display.

4. The multi-panel display device of claim 3, wherein the first and second displays are positioned on first and second sides, respectively, of the unitary device.

5. The multi-panel display device of claim 4, wherein the first and second sides of the unitary device are first and second opposite exterior sides of the unitary device's housing.

6. The multi-panel display device of claim 1, wherein the unitary device comprises a television.

7. The multi-panel display device of claim 6, wherein the television comprises the first display installed on an anterior side of the television's housing and the second display installed on a posterior side of the television's housing.

8. The multi-panel display device of claim 1, wherein the unitary device comprises a computer monitor.

9. The multi-panel display device of claim 1, wherein the unitary device comprises a handheld computing device, a handheld gaming device, a handheld multimedia device, or any other suitable device comprising at least two displays.

10. The multi-panel display device of claim 1, wherein the at least one inner operating component comprises a single inner operating component.

11. The multi-panel display device of claim 1, wherein the single inner operating component is capable of playing the same or different audio/video sources on the at least two displays.

12. The multi-panel display device of claim 1, wherein the unitary device comprises at least one video source and at least one audio source.

13. The multi-panel display device of claim 12, wherein the unitary device comprises first and second video sources and first and second audio sources.

14. The multi-panel display device of claim 13, wherein the first and second displays are capable of displaying the first video source, or the second video source, or one of the first or second video source on the first display and the other of the first or second video source on the second display.

15. The multi-panel display device of claim 14, further comprising a join switch capable of being actuated to cause the first and second displays to play the same audio/video source.

16. The multi-panel display device of claim 5, wherein the first display further comprises a first speaker for playing a first audio source from the first side and the second display further comprises a second speaker for playing a second audio source from the second side.

17. The multi-panel display device of claim 1, further comprising a single first remote control for controlling the at least two displays.

18. The multi-panel display device of claim 1, further comprising at least two separate remote controls programmed for separately controlling each of the at least two displays.

19. The multi-panel display device of claim 1, further comprising a multi-channel audio/video device for playing separate audio/video sources on each of the at least two displays.

20. The multi-panel display device of claim 1, wherein the inner operating component comprises at least one receiver for receiving the at least one audio/video source for playback by the inner operating component on at least one of the at least two displays.
